(19) United States
(12) Patent Application Publication
(10) Pub. No.: US 2026/0048904 A1
(43) Pub. Date: Feb. 19, 2026

(54) DISPOSAL BAGS FOR PADS, TAMPONS, AND OTHER ITEMS

(71) Applicant: Aunt Flow Corp., Columbus, OH (US)

(72) Inventors: Claire Coder, Columbus, OH (US); Gordon Thomas, Mason, OH (US)

(21) Appl. No.: 19/301,410

(22) Filed: Aug. 15, 2025

Related U.S. Application Data
(60) Provisional application No. 63/683,636, filed on Aug. 15, 2024.

(51) Int. Cl. B65D 33/00; B65D 83/08; B65F 1/00

(52) U.S. Cl. CPC B65D 33/002; B65D 83/0805; B65F 1/0006; B65F 2240/164

(57) ABSTRACT

Multiple, separable disposal bags for tampons and pads are wrapped around a center roll. Each bag is connected to the next bag on the roll by a seam that includes a slit and a series of perforations separating connection points between the bags. A bag tail secures the first bag to itself by a bag tail that has an adhesive portion and a free, tab portion. The adhesive portion is attached to the first bag at a first zone and to a different portion of the first bag at a second zone. A user can pull on the free-tab portion of the bag tail to detach the second zone of the adhesive portion from the first bag. The first zone of the adhesive portion remains attached to the first bag after the first bag is detached from the subsequent bag at their seam.

### CROSS REFERENCE TO RELATED APPLICATIONS

This application claims priority and benefit from the U.S. Provisional Patent Application 63/683,636, filed Aug. 15, 2025, and titled, “DISPOSAL BAG FOR PADS, TAMPONS, AND OTHER ITEMS,” which is incorporated herein by reference in its entirety for all purposes.

### BACKGROUND

Many items require or benefit from disposal bags, such as pads, tampons, diapers, personal protective equipment, and the like. The disposal bags are typically flexible, plastic bags that are attached consecutively to each other and rolled around a center core, such as a cardboard tube. They are sometimes placed in dispensers with single or multiple rolls or can be used independently of a dispenser. The multiple bags are usually attached to each other by a perforated seam of connection points that are evenly spaced apart and that extend across the width of the bags and the seam. The first bag on the roll is secured to itself by an adhesive like a sticker or piece of tape to keep the bags rolled around the center core until a user is ready to start using the bags. Users are required to detach the sticker or tape from the first bag to remove it from the roll by tearing seam between the first and subsequent bag. A user can detach subsequent bags by tearing at each perforated seam between consecutive bags. Once detached, the user places their item into the disposal bag to safely discard it.

However, the conventional rolls of bags are often damaged during use, which wastes many bags and frustrates users. For example, users trying to detach the first bag by removing the sticker or tape often tear the first disposal bag because the adhesive used to attach the sticker or tape to the first disposal bag is difficult to remove. That torn first disposal bag becomes waste. Also, the disposal bags are difficult to detach from each other because the perforations between the connection points tend to be small, and the connection points are difficult to detach. Further, because these bags are difficult to detach from each other, the user is often required to use both hands to detach them, which can be difficult when they need their other hand for another action or is simply frustrating to the user that it is a difficult process.

Disposal bags for pads, tampons, and other items need improvements to reduce user frustrations and increase functionality of the disposal bag rolls.

### BRIEF DESCRIPTION OF THE DRAWINGS

Non-limiting and non-exhaustive embodiments of the invention are described with reference to the following drawings. In the drawings, like reference numerals refer to like parts throughout the various figures, unless otherwise specified, wherein:

FIG. 1 is an example disposal bag system in an open position according to aspects of the invention.

FIG. 2 is the example disposal bag system shown in FIG. 1 in a closed position.

FIG. 3 is an example roll of disposal bags.

FIG. 4 is an example bag tail of a roll of disposal bags in accordance with aspects of the invention.

FIG. 5 is the example bag tail shown in FIG. 4 with shaded adhesive regions.

FIGS. 6A and 6B show two example perforated seams between two disposal bags connected on a bag roll.

FIGS. 7A and 7B show additional embodiments of perforated seams between two disposal bags connected on a bag roll.

### DETAILED DESCRIPTION

This disclosure describes various disposal bags and systems of dispensing them. Such disposal bags provide multiple disposal bags attached to one another at a perforated seam, then rolled around a center core, such as a cardboard or plastic tube. The first disposal bag on the roll is attached to itself by a bag tail that allows a user to keep the bags secured on the roll before the first use. The bag tail has an adhesive portion and a free, tab portion. The adhesive portion attaches the end of the first bag to itself so it can be secured and/or stored before the first use. The adhesive portion has multiple zones that each have adhesive, but release from the bag at different detachment forces. Each zone can have different adhesive entirely or could have a different volume or concentration of the adhesive. The first zone of adhesive requires the most force to detach from the bag while the second zone of adhesive requires the least force to detach. The first zone secures the bag tail to the bag and has a detachment force that exceeds the typical force applied by a user when the user wishes to detach the first bag from the roll. The second zone secures the bag to itself to keep the roll intact before its first use but has a detachment force that is easily applied by a user when the user wishes to begin using the bag. Essentially, the user can apply a force to the free, tab portion of the bag that detaches the second zone but not the first zone of the adhesive portion from the bag. This two adhesive zone approach allows the user to easily detach the first bag from the roll without damaging the first bag. Conventional systems that use a sticker or tape to secure the first bag to itself on the roll often cause damage to the first bag by tearing or stretching it, which can result in the first bag being discarded. These conventional stickers or tape have only one type, volume, and/or concentration of adhesive to secure it to both the end of the first disposal bag and a spaced apart location on the first disposal bag, which means there is only a single detachment force used to detach the sticker or tape from the first bag. When the user of a conventional bag roll pulls on the sticker or tape, it detaches itself from the first bag but also may entirely detach from the disposal bag making it difficult to then unroll the first bag, or it can tear or otherwise damage the first bag, which causes waste.

Once the second zone of the adhesive portion is detached from the disposal bag, the user continues to apply force to the bag tail by pulling on the free, tab portion to unroll the first bag from the roll up to the seam that separates the first bag and the second bag. The force required to detach the first zone of the adhesive portion from the disposal bag is larger than the force applied by the user to unroll the disposal bag, which allows the bag tail to remain attached to the disposal bag during this process. When the user continues to apply this force, the bag unrolls from the bag roll or can be pulled through a dispenser system with ease. Conventional bag rolls require removal of the sticker or tape from the first bag, which often break, tear, or detach from the bag leaving the user with little or nothing to grasp to apply the force necessary to unroll the first bag from the roll. In an example, the detachment force to remove the bag tail from the second zone is 3.7 ounces of force and can be less or greater than that. In the same example, the detachment force to remove the bag tail from the first zone is 18.3 ounces of force, which can also be more or less than this. Alternatively, a ratio of 1:5 of the force required to detach the second zone compared to the force required to detach the first zone of the bag tail can be employed to ensure that the second zone easily detaches while the first zone remains attached to the first bag (or subsequent bag as the case may be) while the user applies force to the bag tail to unroll the first bag. This results in the user having difficulty unrolling the first bag for use, which can be nearly impossible if the bag roll is in a dispenser housing because the user cannot easily reach into the housing to fetch the end of the first bag. The disclosed bag tail solves this problem of the conventional systems.

The free, tab portion is detached from the bag roll and allows a user to grasp it, then detach the adhesive portion from the first bag without tearing the first bag or risking damaging it another way. The design of the free, tab portion allows a user to detach the bag tail from the first disposal bag with one hand, if desired, which improves user ease of use and satisfaction. The free, tab portion is not attached to the bag and simply extends from the adhesive portion as a type of pull, handle, or grip. When the bag roll is a single roll, the user wishes to begin using, the user can hold the bag roll while pulling on the free, tab portion of the bag tail to detach the second zone while the first zone of the adhesive portion remains attached to the first bag, which allows the user to unroll the first bag from the bag roll. When the bag roll is in a dispenser, oftentimes with multiple bag rolls stacked upon each other in a vertical arrangement, the bag roll lowest in the stack has the bag tail exposed, which the user can pull to detach the second zone from the first bag while the first zone of the adhesive portion remains attached to the first bag. This pulling force to unroll the disposal bag causes the first disposal bag to be dispensed from the dispenser.

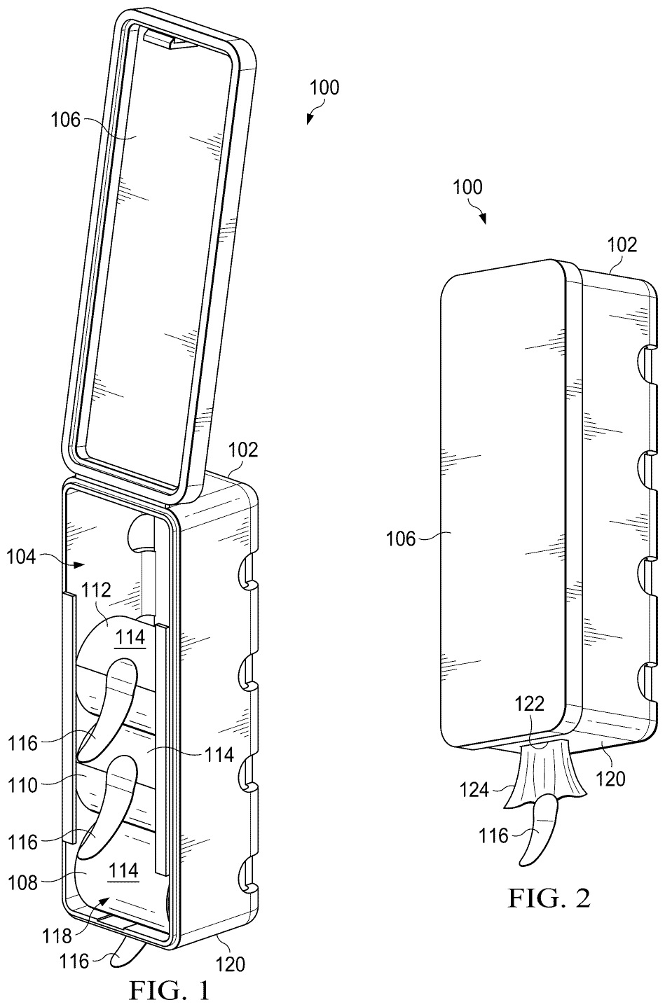

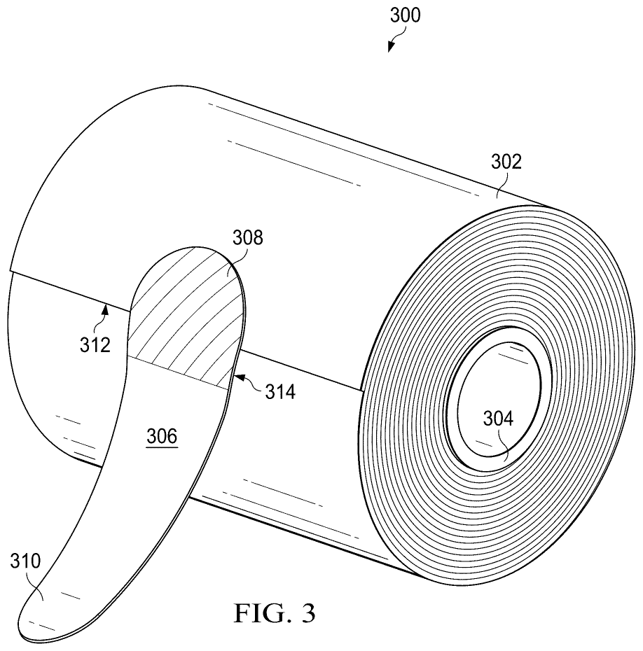

FIGS. 1 and 2 show a bag roll dispenser 100 that has a housing 102 with an interior cavity 104 and a door 106. The bag roll dispenser 100 has a door 106 that is shown in an open position in FIG. 1 and a closed position in FIG. 2. Multiple bag rolls 108, 110, 112 are vertically stacked on each other in the interior cavity 104 of the housing 102. The first bag roll 108 in the stack has the greatest force applied to it from the weight of the other stacked bag rolls 110, 112 due to gravity. Each of the bag rolls 108, 110, 112 have multiple rolled bags 114 secured on the roll by a bag tail 116 that prevents the bag roll from unrolling before its first use. The bag tails 116 of the second bag roll 110 and the third bag roll 112 are freely suspended in the housing 102 until their respective bag rolls 110, 112 are ready for use. The diameter of the first bag roll 108 decreases as each bag is used in the roll 108. When all the bags are used on the first bag roll 108, only its center core remains. The center core is removed which moves the second bag roll 110 to a dispensing position 118 in bottom of the dispenser so the second bag roll 110 is then ready for deployment.

The center roll of the first bag roll 108 can be removed by any suitable means including opening the housing and removing it. In another example, the center core can be removed by pushing the center roll out of the housing through openings in the opposing side walls to allow the second bag roll 110 to move to a dispensing position to deploy its bags. The user inserts their finger through an opening on one side wall to push the center core through the opening on the opposing side wall to dispense it. As the bags of the second bag roll are used, the same process repeats for the third bag roll 112 to then move to the dispensing position 118 at the bottom of the dispenser 100 in a similar manner.

The dispensing position 118 is located at the bottom of the interior cavity 104 of the dispenser 100 and includes a slit 120 through which the bag tail 116 of a first bag 124 is inserted—or whichever bag roll 108, 110, 112 is in the dispensing location 118. The bag tail 116 and an end of the first bag 124 to which the bag tail 116 is attached is exposed on the exterior surface of the housing 102. A user can grasp the bag tail 116 and apply a force that detaches a portion of the bag tail from the first bag on the 124 of the bag rolls 108, 100, 112, to dispense the first bag 124 through the slit 122 of the dispenser 100. A portion of the bag tail 116 remains attached to the first bag when it is dispensed. The first bag 124 is connected to a subsequent second bag by a perforated seam (not shown in FIGS. 1 and 2). The user detaches the first bag 124 from the second bag outside of the dispenser 100 shown in FIGS. 1 and 2, which causes an end of the second bag to be pulled through the slit 122. When the user wishes to detach the second bag from the bag roll, the user grasps the end of the second bag that is inserted through the slit 122 and exposed on the exterior of the housing 102 of the dispenser 100. When the first bag roll 108 is empty, the user removes the center core, as described above, the inserts their finger through the slit 120 on the bottom surface of the housing to rotate the second bag roll 110 that has moved to the dispensing position until the free, tab portion of its bag tail is exposed and can be fed through the slit 120. The dispenser 100 shown in FIGS. 1 and 2 are often attached to a surface, such as a bathroom wall or other surface to easily dispense to user(s) when needed.

FIG. 3 shows a single bag roll 300, which can be used by itself or can also be included in the dispenser 100 shown in FIGS. 1 and 2. When used by itself, the bag roll 300 can easily be stored in a bag, purse, or other personal item for easy transport. The bag roll 300 includes multiple disposal bags 302 attached to each other by a perforated seam (not shown here) and rolled around a center core 304. The center core 304 is a hollow tube in the example shown in FIG. 3 but could be a solid cylinder or other shape around which the multiple disposal bags 302 are rolled. The center core 304 can be a plastic or cardboard material in some examples or another material, as desired. The bag tail 306 has an adhesive portion 308 that is attached to a terminal end 312 of the first disposal bag 302 and another portion 314 of the first disposal bag 302. The free, tab portion 310 of the bag tail 306 is not attached to the disposal bag 300 and allows the user to grasp and apply force to it to detach a portion of the adhesive portion 308 of the bag tail 306 from the portion of the first disposal bag 314 that is spaced apart from the bag end 312. The adhesive portion 308 remains attached to the end of the first disposal bag when the force is applied by the user, which allows the user to unroll the first disposal bag 302 from the bag roll 300 without damaging the first disposal bag 302.

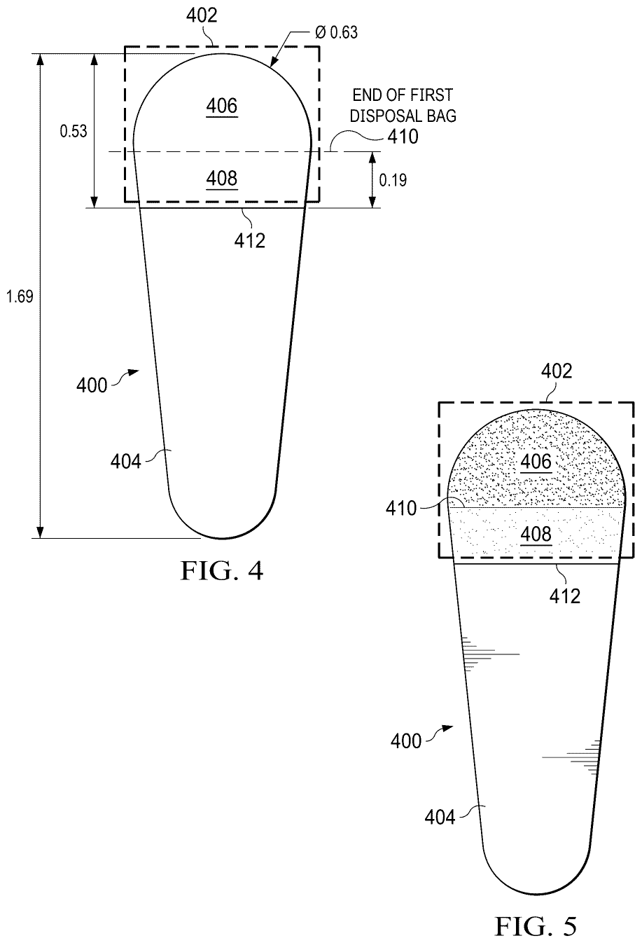

FIGS. 4 and 5 show a bag tail 400 similar to the bag tails 116, 306 shown in FIGS. 1-3. This bag tail 400 is tapered from its adhesive portion 402 towards its free, tab portion 404, which means the width of the free, tab end 404 is smaller than the width of the adhesive portion 402. In this example, the taper is straight and gradual, which leaves no vulnerable joint along the bag tail when the user applies the necessary force to detach the bag tail 400 from the disposal bag. Both the adhesive portion 402 and the free, tab portion 404 have rounded ends but could be other shapes in another embodiment. The rounded ends helps to prevent the adhesive portion 402 and the free, tab portion 404 from having a corner of a polygonal shape catch or snag on an object, for example. The adhesive portion 402 includes adhesive that attaches to an end of the first bag on a bag roll and another portion spaced along the length of the disposal bag 412 that is rolled around the bag roll. The adhesive portion 402 includes two zones of adhesive—a first zone 406 and a second zone 408. The separation between the first zone 406 and the second zone 408 occurs at the end 410 of the first disposal bag, such that the adhesive portion 402 is attached to both the end 410 of the first disposal bag and a spaced apart portion of the disposal bag. The end of second zone that correlates to the spaced apart portion 412 is the divider between the adhesive portion 402 and the free, tab portion 404.

The first zone 406 and the second zone 408 of the adhesive portion 402 can vary in some feature related to the adhesive. Each of the first zone 406 and the second zone 408 have adhesive, but the adhesive could be a different concentration, volume, or type of adhesive. The adhesive in the first zone could extend over the entire surface area of the first zone 406 while the adhesive in the second zone could extend over a partial surface area of the second zone 408. In other examples, the adhesive extends over the entirety of both the first zone 406 and the second zone 408. Multiple adhesives can be used in some examples and could be mixed together to create a combination adhesive or could be used to secure different regions of the same or different zones of the adhesive portion of the bag tail.

The adhesive portion is shown in FIG. 4 with example dimensions, which can vary depending on the size of the bag tail that may be needed or other reasons. In this example, the adhesive portion 402 is approximately 30+% of the bag tail 400, and the free, tab portion 404 is approximately 60+% of the bag tail 400. Within the adhesive region 402, the first zone 406 that is secured to the end of the first disposal bag is slightly less than three times the height of the second zone 408 and slightly wider. This difference in the size of the first zone 406 and the second zone 408 correlates to the force required to be applied by the user to detach each respective zone from the first disposal bag. The force required to detach the second zone 408 needs to be lower than the force required to detach the first zone 406. The difference in the detachment force for the first zone 406 and the second zone 408 is related to the difference in the adhesive feature between them, such as the volume, concentration, type, and application of the adhesive to each zone.

Most of the embodiments discussed herein have bag rolls that range from 1-3+ inches in diameter, which means the second zone of the adhesive portion is attached to the spaced part portion of the first disposal bag on the bag roll. However, another embodiment may include a bag roll that is much larger in diameter with many more disposal bags connected at perforated seams and rolled around the center roll. In these examples, depending on the length of the disposal bags, it is possible that the first zone of the adhesive portion is connected to the end of the first disposal bag, but the roll has a wide enough diameter that the second zone of the adhesive portion is attached to a second (or other subsequent) bag on the bag roll.

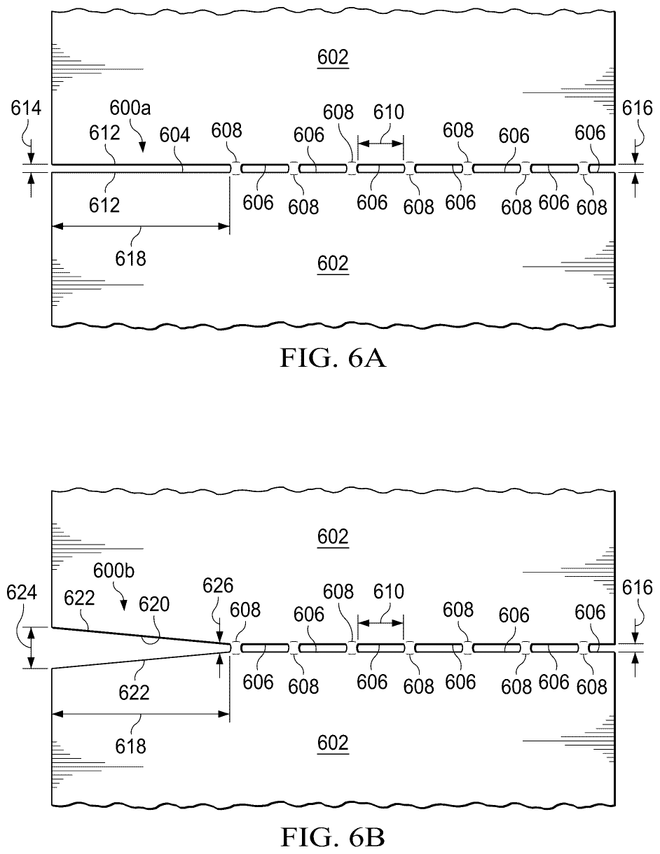

FIGS. 6A and 6B show example perforated seams 600a, 600b between disposal bags 602 connected consecutively with each other on the disposal bag roll. The perforated seam 600a in FIG. 6A has a slit 604 and a series of perforations 606 with connection points 608 separating each perforation 606 and uniform sized widths 610 for each perforation 606. In this example, the slit is U-shaped such that ends 612 of the consecutive disposal bags 602 have a height 614 that is similar along its entire width and also similar to or the same as a height of the perforations 616. The width of the slit 618 is larger than the width 610 of any of the individual perforations. In the example shown in FIG. 6A, the width of the slit 618 is the width of four perforations 606 and connection points 608 between them. The slit 604 can have a different width in other configurations relative to the perforations 606 and connection points 608. A user is able to easily separate the consecutive disposal bags 602 attached at the seam 600a by grasping one or the other of the ends 612 of the disposal bags 602 at the slit 604.

The user applies a diagonal force to the grasped end, which then tears the connection point 608 nearest the slit 604 along a lateral seam. When the user continues to apply a diagonal force to the grasped end of the disposal bag 602, each subsequent connection point 608 tears in order until the final connection point 608 is torn and the two disposal bags are separated. The diagonal force includes a combination of a lateral and a vertical force that, together, pull the bag through the slit 604 to be dispensed. The vertical force of the diagonal force needs to be higher than the lateral force so the bag does not separate from the subsequent bag before it is dispensed through the slit 604 of the dispenser housing. The slit 604 provides the user with a “starting” separated between the disposal bags 602 and also provides a larger portion to grasp to apply the necessary force to tear the series of connection points 608 between the perforations. In convention perforated seams, there is no slit and only a series of perforations and connection points. Users have difficulty grasping a small end of the perforated seam because it has such a small surface area. The force required to separate the first connection point on the conventional seam in then greater than with the new slit arrangement and has less surface area for the user to grasp, which makes applying that force harder.

FIG. 6B shows another embodiment of a perforated seam 600b between two disposal bags 602 with a slit 620 that is V-shaped and creates a tapering height or distance between the two edges 622 of the connected disposal bags 602. The V-shaped slit 620 has a height 624 that is larger at lateral edges of the disposal bags 602 and narrows in a tapering manner to a V-shaped point having a smaller height 626 nearest the connection point 608 that is nearest the slit 620. The height of the V-shaped point 626 is approximately or the same as the height of the perforations 616. Similar to the embodiment shown in FIG. 6A, all the multiple perforations 606 are similar or the same widths 620. The V-shaped slit 620 allows a user to grasp a corner or edge of the end of the disposal bag 612 to apply the lateral force needed to tear the consecutive connection points 608.

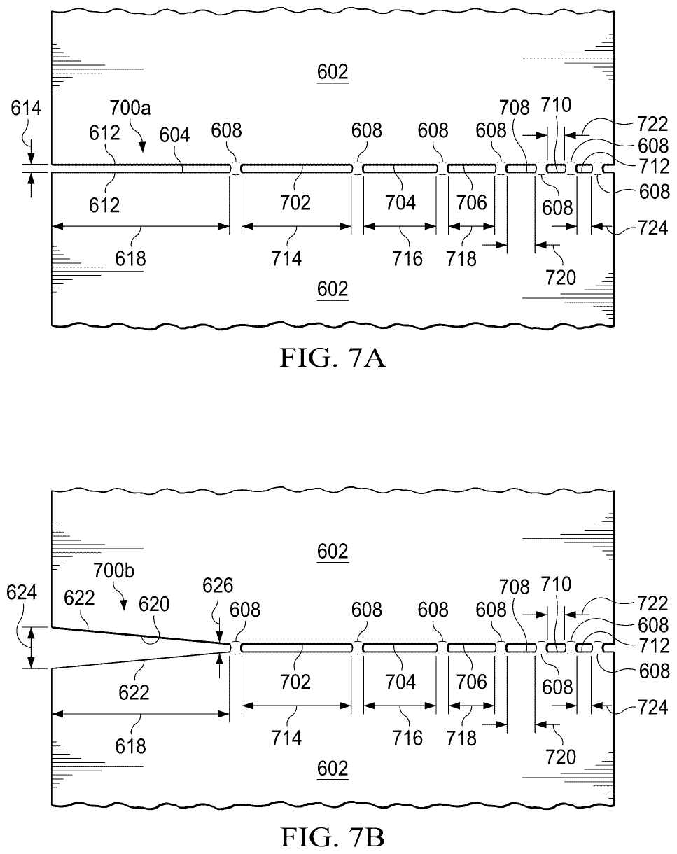

FIGS. 7A and 7B show yet more embodiments of a perforated seam 700a, 700b between two disposal bags 602. FIG. 7A has a U-shaped slit 604 that is similar to or the same as the slit 604 in FIG. 6A. FIG. 7B has a V-shaped slit 620 that is similar to or the same as the slit 620 in FIG. 6B. The perforations 702, 704, 706, 708, 710, 712 are separated by connection points 608 that are similar to the embodiments of the perforated seams 600a, 600b shown in FIGS. 6A and 6B. The difference in the embodiments shown in FIGS. 7A and 7B compared to those shown in FIGS. 6A and 6B is that each of the perforations 702, 704, 706, 708, 710, 712 have different sized widths 714, 716, 718, 720, 722, 724. The perforation 702 nearest the slits 604, 620 have the largest width 714 with the perforation widths decreasing at they move away from the slits 604, 620 with the perforation 712 having the smallest width 724 being farthest from the slits 604, 620, respectively. The differing sizes of the perforations allow a greater section of the seam to be detached when the user applies the lateral force to the first connection point than if the perforations were of the same width.

The subject matter of embodiments disclosed herein is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments will be described more fully hereinafter with reference to the accompanying drawings, which form a part hereof, and which show, by way of illustration, exemplary embodiments by which the systems and methods described herein may be practiced. The systems and methods may, however, be embodied in many different forms and should not be construed as limited to the embodiments set forth herein; rather, these embodiments are provided so that this disclosure will satisfy the statutory requirements and convey the scope of the subject matter to those skilled in the art.

What is claimed is:

1. A roll of disposal bags for pads, tampons, and other items, the roll of disposal bags comprising:
a center core tube;
multiple, separable disposal bags rolled around the center roll; and
a bag tail having:
an adhesive portion having a first zone of adhesive and a second zone of adhesive, the adhesive portion attached to an end of a first disposal bag of the multiple, separable disposal bags within the first zone and to either another portion of the first disposal bag or a subsequent disposal bag within the second zone;
a free, tab portion extending away from the end of the first bag roll and unattached from any of the multiple, separable disposal bags.

2. The roll of disposal bags of claim 1, wherein the multiple separable disposal bags are separable by a perforated seam.

3. The roll of disposal bags of claim 2, wherein the seam includes a series of perforations separating connection points between consecutive separable disposal bags and a slit.

4. The roll of disposal bags of claim 3, wherein the series of perforations between the connection points are spacings of the same width.

5. The roll of disposal bags of claim 3, wherein at least some of the perforations between the connection points are spacings of different widths.

6. The roll of disposal bags of claim 3, wherein a width of a perforation between the connection points is smallest at an edge of the seam and progressively increases in size as the perforations progress toward the slit until the perforation with the largest width is adjacent the slit.

7. The roll of disposal bags of claim 3, wherein the slit is a U-shape.

8. The roll of disposal bags of claim 3, wherein the slit is a V-shape.

9. The roll of disposal bags of claim 1, wherein the first zone of adhesive has a different volume of adhesive than the second zone of adhesive.

10. The roll of disposal bags of claim 1, wherein the first zone of adhesive has a different concentration of adhesive than the second zone of adhesive.

11. The roll of disposal bags of claim 1, wherein the first zone of adhesive has a different type of adhesive than the second zone of adhesive.

12. The roll of disposal bags of claim 1, wherein the adhesive covers the entirety of the first zone.

13. The roll of disposal bags of claim 1, wherein the adhesive covers a portion of the second zone.

14. The roll of disposal bags of claim 1, wherein the adhesive covers the entirety of the first zone and the second zone.

15. The roll of disposal bags of claim 1, wherein a detachment force to detach the second zone of the adhesive from the first bag or the subsequent bag is less than a detachment force to detach the first zone of the adhesive from the first bag.

16. The roll of disposal bags of claim 15, wherein the detachment force to detach the second zone of the adhesive from the first bag or the subsequent bag is 3.7 ounces of force, and the detachment force to detach the first zone of the adhesive from the first bag is 18.3 ounces of force.

17. The roll of disposal bags of claim 1, wherein a detachment force to detach the second zone of the adhesive from the first bag or the subsequent bag compared to a detachment force to detach the first zone of the adhesive from the first bag is a 1:5 ratio.

18. The roll of disposal bags of claim 1, wherein first zone is larger than the second zone.

19. The roll of disposal bags of claim 1, wherein the bag tail is tapered and has two rounded ends.

20. The roll of disposal bags of claim 1, wherein the free, tab portion has a smaller width than the adhesive portion.

21. The roll of disposal bags of claim 1, wherein free, tab portion is a majority of the bag tail over the adhesive portion.

22. The roll of disposal bags of claim 1, wherein the free, tab portion has no adhesive.
